(19) United States
(12) Patent Application Publication
(10) Pub. No.: US 2024/0362946 A1
(43) Pub. Date: Oct. 31, 2024

(54) METHOD AND SYSTEM FOR MONITORING THE OCCUPANCY OF A STRUCTURE

(71) Applicant: Tom Nepola, Ridgewood, NJ (US)

(72) Inventor: Tom Nepola, Ridgewood, NJ (US)

(21) Appl. No.: 18/443,816

(22) Filed: Feb. 16, 2024

Related U.S. Application Data
(60) Provisional application No. 63/462,388, filed on Apr. 27, 2023.

(51) Int. Cl. G06V 40/10; G06T 7/292; G06V 10/82; G06V 20/52

(52) U.S. Cl. CPC G06V 40/10; G06T 7/292; G06V 10/82; G06V 20/52; G06T 2207/20081; G06T 2207/20084; G06T 2207/30196; G06T 2207/30232; G06T 2207/30242; G06V 2201/10

(57) ABSTRACT

A system for monitoring occupancy of a structure includes at least one camera configured to acquire an image of the structure; processor circuitry coupled with a memory configured to process the image; and an output device; wherein, in order to process the image, the processor circuitry is configured to: detect an object in the image; extract one or more features of the object; identify whether the object is a person; associate a unique tracker with each identified person; keep track of the identified people in the structure; calculate a load on the structure based on an attribute of each person; and instruct the output device to generate an output signal when the calculated load reaches a predetermined threshold.

### CROSS-REFERENCE TO RELATED APPLICATION

This application claims a priority under 35 U.S.C. 119 (e) to U.S. Provisional Application No. 63/462,388, filed on Apr. 27, 2023, the entire contents of which are incorporated herein by reference.

### FIELD

The disclosure generally relates to a method and system for monitoring the occupancy of a structure. More particularly, the disclosure relates to a method and system utilizing a neural network for real-time monitoring of the occupants in a structure and determining whether a load on the structure has reached a predetermined threshold.

### BACKGROUND

Typically, a building structure will have an occupancy limit based on the maximum weight the structure can support. Building codes typically specify the maximum number of occupants based on the maximum supported load of the structure. For many structures, such as a deck, bridge, stage, etc., it is very expensive, inconvenient or even impossible to weigh all the occupants. Therefore, many existing systems just count the number of people on the structure to determine whether an occupancy limit has been reached. However, the weight of an occupant can vary greatly; for example, an adult can weigh a few times more than a toddler. Thus, just relying on the number of occupants may not provide an accurate assessment of whether the load capacity of the structure has been reached.

Furthermore, during use, some occupants may leave the structure, new people may enter structure, and some who left may reenter the structure. Thus, some existing systems that keep only static or non-real-time counts may result in false positive or false negative alarm that the capacity has been reached.

Therefore, there is long felt need for a method and system that can provide real-time monitoring of the occupants in a structure and can overcome the problems and shortcomings that plague the existing systems and processes discussed above.

### SUMMARY

An embodiment of the present disclosure provides a system for monitoring occupancy of a structure, including: at least one camera configured to acquire an image of the structure; a processor coupled with a memory device configured to process the image; and an output device; wherein the processing of the image includes: detecting an object in the image; extracting one or more features of the object; identifying whether the object is a person; associating a unique tracker with each identified person; keeping track of the identified people in the structure; calculate a load on the structure based on an attribute of each person; and instructing the output device to generate an output signal when the calculated load reaches a predetermined threshold.

An embodiment of the present disclosure provides a method of monitoring occupancy of a structure, including: acquiring an image of the structure; processing the image; and generate an output based on a result of the processed image; wherein the processing of the image includes: detecting an object in the image; extracting one or more features of the object; identifying whether the object is a person; associating a unique tracker with each identified person; keeping track of the identified people in the structure; calculate a load on the structure based on an attribute of each person; and generating an output signal when the calculated load reaches a predetermined threshold.

### BRIEF DESCRIPTION OF THE DRAWINGS

FIG. 1 shows the operation of an occupancy monitoring system according to an embodiment.

FIG. 2 is a block diagram of an occupancy monitoring system according to an embodiment.

FIG. 3 shows the SE block architect of an occupancy monitoring system according an embodiment.

### DETAILED DESCRIPTION

The description of illustrative embodiments according to principles of the present disclosure is intended to be read in connection with the accompanying drawings, which are to be considered part of the entire written description. In the description of embodiments of the disclosure disclosed herein, any reference to direction or orientation is merely intended for convenience of description and is not intended in any way to limit the scope of the present disclosure. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the disclosure are illustrated by reference to the exemplified embodiments. Accordingly, the disclosure expressly should not be limited to such exemplary embodiments illustrating some possible non-limiting combination of features that may exist alone or in other combinations of features; the scope of the disclosure being defined by the claims appended hereto.

This disclosure describes the best mode or modes of practicing the disclosure as presently contemplated. This description is not intended to be understood in a limiting sense, but provides an example of the disclosure presented solely for illustrative purposes by reference to the accompanying drawings to advise one of ordinary skill in the art of the advantages and construction of the disclosure. In the various views of the drawings, like reference characters designate like or similar parts.

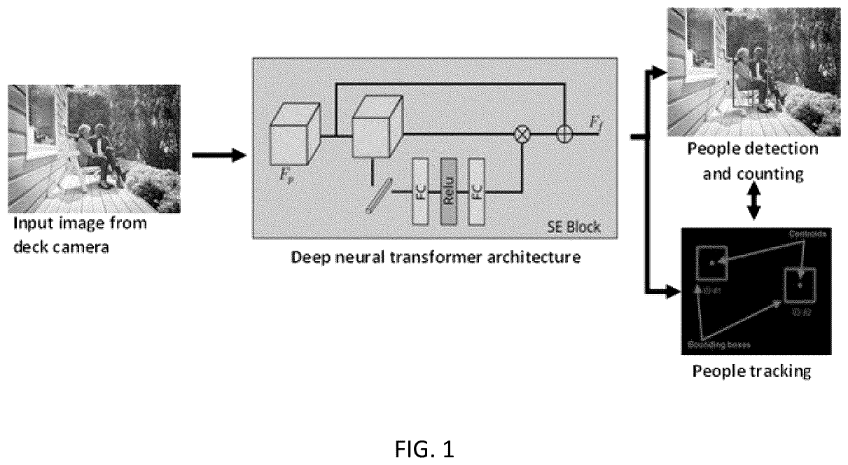

FIG. 1 shows an example operation of an occupancy monitoring system according to an embodiment. In this example, the structure of interest is a deck, on which the occupants are monitored by the system. One or more cameras are installed to obtain life images of objects on the deck. The images are analyzed by the system to identify human forms, and count the number of identified humans. The system keeps track of each detected person, and the system generates an alarm if a predetermined load limit on the deck has been reached.

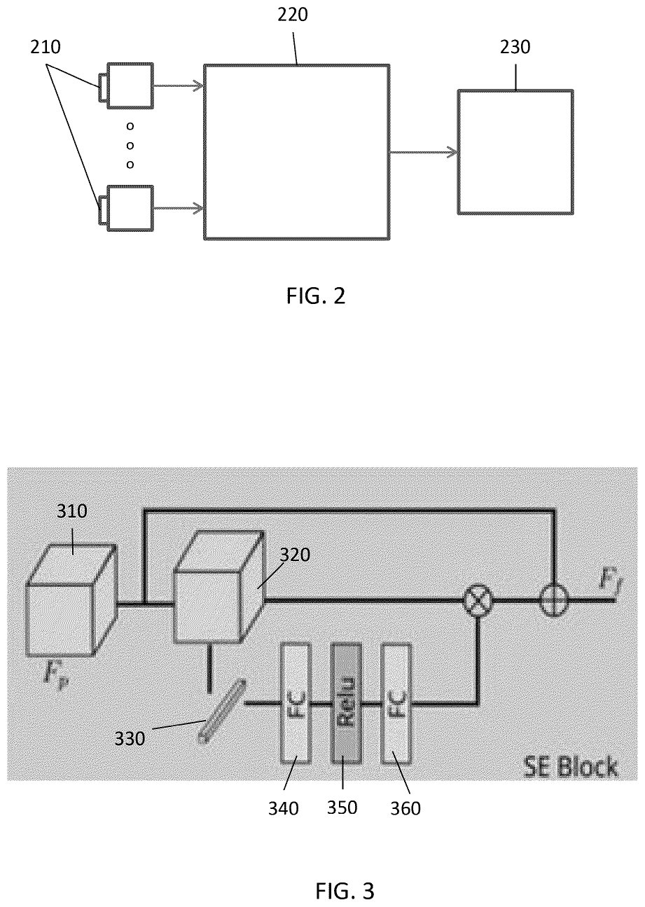

FIG. 2 is a block diagram view of a monitoring system according to an embodiment. One or more cameras 210 are installed at various locations to obtain images of the deck from different directions. The system utilities machine learning tools implemented as deep neural network transformer 220 for real-time video analytics, feature extraction, object detection, and tracking. When a predetermined threshold has been reached, an alarm is raised by an output device 230. The alarm generated by the output device 230 can be, for example, audio, visual, text message alarm, local and/or remove alarms, etc. In one embodiment, the operation framework includes the following stages:

Stage 1: Input Image from Deck Camera:

In an example embodiment, the monitoring system uses a single camera image in at least full HD (1080) resolution to gather a real-time video stream monitoring the state of the deck. Due to its flexible nature, the system can work with any camera model, as it is used for video feed to hardware on which the algorithm runs. The camera setup should allow for the field of view to cover the entire deck. If needed, the system can be extended to multiple cameras, allowing for monitoring larger spaces. In such a case a multi-source version of the deep neural transformer is being used for video processing.

### Stage 2: Deep Neural Transformer:

In one embodiment, the monitoring system uses a model for image classification, for example, Vision Transformer, as its deep neural network backbone. The process of the Vision Transformer model can be broken down into two main steps: tokenization and the Transformer encoder. During tokenization, an image is cropped into L equal (h×h) patches and flattened into a vector. A learnable vector is added as a token for classification, and each vector is assigned a position value. The input to the Transformer encoder consists of L+1 vectors, each with a length of h²+1. The Transformer encoder is comprised of a sequence of N blocks, each containing an attention module. The Multi-Head Attention (MHA) is the primary component of the attention block, which is constructed with z heads of self-attention (also known as intra-attention). The purpose of self-attention is to establish connections between different positions of a single sequence in order to derive a sequence representation. For a given sequence, the self-attention function utilizes Q-layer, K-layer, and V-layer, and it maps a query (Q or Q-layer) and a set of key-value (K or K-layer; V or V-layer) pairs to an output, typically consisting of three layers.

### Stage 3: Squeeze and Excitation (SE) Block

The SE block is a variant of the attention mechanism that requires significantly fewer parameters than the self-attention block. FIG. 3 shows the SE block which transform input features into an output features. According an embodiment. Input feature volume 310 is transformed by convolution into an intermediate feature volume 320. The SE block employs two fully connected layers (FC) 340 and 360 with a single pointwise multiplication operation, compared to the self-attention block's greater complexity. The rectified linear unit (ReLU) 350 between the two FC provides an activation function that adds the necessary nonlinearity. In one embodiment, the system utilizes the excitation mechanism of the SE block, in which the squeeze component 330 is a pooling layer designed to reduce the dimensions of 2D-convolutional neural network (CNN) layers. The system architecture leverages the SE block to optimize the Vision Transformer's learning by enhancing global attention relationships between local attention features. Consequently, the present disclosure proposes to introduce the SE block on top of the Transformer encoder, specifically on the classification token vector. Unlike the self-attention block, which operates within the Transformer encoder to encode the input sequence and extract features, the SE block recalibrates feature responses by modeling inter-dependencies among all channels.

### Stage 4: Detecting and Counting

This phase uses the dedicated deep neural network architecture to (a) decide if there is a new person entering the scene (i.e., the monitored deck); and (b) examine if a previously tracked and marked person that left the scene has re-entered it again. For new people entering the deck, they are assigned with a unique tracker (marker), and for people re-entering the scene, the trackers already assigned to them are updated.

### Stage 5: Tracking

For each detected person, we create a tracker that consists of meta-data (e.g., body features, size, estimated weight, etc.) describing the detected person. This allows the system to keep an up-to-date counter of how many people are currently on the deck and avoid false positives and negatives that would occur while people are under different light conditions, are overlapping, or obstructing view of some of them. This way, the system will always keep the vector of trackers until the person leaves the deck, leading to robustness to false alarms.

Those stages are running in parallel to allow for real-time person counting and tracking, thus leading to real-time and quick alarms if the capacity of the deck has been reached. In one embodiment, the system determines the real-time load based on the estimated weight of each detected person currently on the deck. This approach gives a more accurate real-time determination of whether the deck is overloaded, and hence provides a better safety feature to the structure.

While the present disclosure has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the related art and, therefore, to effectively encompass the intended scope of the disclosure. Furthermore, the foregoing describes the disclosure in terms of embodiments foreseen by the inventor for which an enabling description was available, notwithstanding that insubstantial modifications of the disclosure, not presently foreseen, may nonetheless represent equivalents thereto.

The methods/apparatuses described with reference to the embodiments of this disclosure may be directly embodied as hardware, software modules executed by a processor, or a combination thereof. For example, one or more functional block diagrams and/or one or more combinations of the functional block diagrams may either correspond to software modules of procedures of a computer program, or correspond to hardware modules. The hardware module, for example, may be carried out by firming the soft modules by using for example, a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of functional block diagrams may also be realized as a combination of computing equipment, such as a combination of a DSP and a microprocessor, multiple processors, one or more microprocessors in communication combination with a DSP, or any other such configuration.

As to implementations including the above embodiments, following supplements are further disclosed.
1. A system for monitoring occupancy of a structure, comprising:
at least one camera configured to acquire an image of the structure;
a processor coupled with a memory device configured to process the image; and
an output device;
wherein the processing of the image comprises:
   detecting an object in the image;
   extracting one or more features of the object;
   identifying whether the object is a person;
   associating a unique tracker with each identified person;
   keeping track of the identified people in the structure;
   calculate a load on the structure based on an attribute of each person; and
   instructing the output device to generate an output signal when the calculated load reaches a predetermined threshold.
2. The system of claim 1, wherein the system comprises a plurality of camera arranged at different location and configured to acquire a plurality of images from different directions at the same time; and wherein the processing is based on the plurality of acquired images.
3. The system of claim 1, wherein the one or more features comprise human features.
4. The system of claim 1, wherein each tracker comprises meta-data associated with the corresponding person.
5. The system of claim 4, wherein the meta-data comprises physical attributes of the person.
6. The system of claim 5, wherein the physical attributes include an estimated weight of the person.
7. The system of claim 1, wherein keeping track of the identified people comprises counting the number of people currently in the structure and adjusting the number when a new person enters the structure, a person leaves the structure, or a person who has left the structure re-enters the structure.
8. The system of claim 1, wherein the processor executes a machine learning tool program code.
9. The system of claim 8, wherein the machine learning tool is implemented as a deep neural network transformer for real-time video analytics, feature extraction, object detection, and tracking.
10. The system of claim 1, wherein each of the unique tracker is stored in the memory until the person associated with the tracker leaves the structure.
11. A method of monitoring occupancy of a structure, comprising:
acquiring an image of the structure;
processing the image; and
generate an output based on a result of the processed image;
wherein the processing of the image comprises:
   detecting an object in the image;
   extracting one or more features of the object;
identifying whether the object is a person;
associating a unique tracker with each identified person;
keeping track of the identified people in the structure;
calculate a load on the structure based on an attribute of each person; and
generating an output signal when the calculated load reaches a predetermined threshold.

What is claimed is:

1. A system for monitoring occupancy of a structure, comprising:
at least one camera configured to acquire an image of the structure;
processor circuitry coupled with a memory configured to process the image; and
an output device;
wherein, in order to process the image, the processor circuitry is configured to:
detect an object in the image;
extract one or more features of the object;
identify whether the object is a person;
associate a unique tracker with each identified person;
keep track of the identified people in the structure;
calculate a load on the structure based on an attribute of each person; and
instruct the output device to generate an output signal when the calculated load reaches a predetermined threshold.

2. The system of claim 1, wherein the system comprises a plurality of camera arranged at different location and configured to acquire a plurality of images from different directions at the same time; and wherein the to process the image is based on the plurality of acquired images.

3. The system of claim 1, wherein the one or more features comprise human features.

4. The system of claim 1, wherein each unique tracker comprises meta-data associated with the corresponding person.

5. The system of claim 4, wherein the meta-data comprises physical attributes of the person.

6. The system of claim 5, wherein the physical attributes include an estimated weight of the person.

7. The system of claim 1, wherein the to keep track of the identified people comprises to count the number of people currently in the structure and to adjust the number when a new person enters the structure, a person leaves the structure, or a person who has left the structure re-enters the structure.

8. The system of claim 1, wherein the processor circuitry is configured to execute a machine learning tool program code.

9. The system of claim 8, wherein the machine learning tool is implemented as a deep neural network transformer for real-time video analytics, feature extraction, object detection, and tracking.

10. The system of claim 1, wherein each of the unique tracker is stored in the memory until the person associated with the tracker leaves the structure.

11. A method of monitoring occupancy of a structure, comprising:
acquiring an image of the structure;
processing the image by processor circuitry; and
generate an output based on a result of the processed image;
wherein the processing the image comprises:
detecting an object in the image;
extracting one or more features of the object;
identifying whether the object is a person;
associating a unique tracker with each identified person;
keeping track of the identified people in the structure;
calculating a load on the structure based on an attribute of each person; and
generating an output signal when the calculated load reaches a predetermined threshold.

12. The method of claim 11, further comprising:
arranging a plurality of camera arranged at different location; and
acquiring a plurality of images from different directions at the same time, and
wherein the processing is based on the plurality of acquired images.

13. The method of claim 11, wherein the one or more features comprise human features.

14. The method of claim 11, wherein each unique tracker comprises meta-data associated with the corresponding person.

15. The method of claim 14, wherein the meta-data comprises physical attributes of the person.

16. The method of claim 15, wherein the physical attributes include an estimated weight of the person.

17. The method of claim 11, wherein the keeping track of the identified people comprises counting the number of people currently in the structure and adjusting the number when a new person enters the structure, a person leaves the structure, or a person who has left the structure re-enters the structure.

18. The method of claim 11, further comprising:
executing a machine learning tool program code by the processor circuitry.

19. The method of claim 18, wherein the machine learning tool is implemented as a deep neural network transformer for real-time video analytics, feature extraction, object detection, and tracking.

20. The method of claim 11, wherein each of the unique tracker is stored in a memory until the person associated with the tracker leaves the structure.
